(19) United States
(12) Patent Application Publication
(10) Pub. No.: US 2008/0049424 A1
(43) Pub. Date: Feb. 28, 2008

(54) Decorative light string with C-type lamps

(76) Inventor: Yi-Jou Wang, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/507,429

(22) Filed: Aug. 22, 2006

(51) Int. Cl. F21V 21/00

(52) U.S. Cl. 362/249; 362/391; 362/806

(57) ABSTRACT

The invention relates to a decorative light string, which includes a main light string having several lamp holders to engage with related C-type lamps, a branch string having one end a screw-head. The branch string can have its screw-head engage with a lamp holder of the main string, which then includes several C-type lamps and several branch strings that facilitates the application on any decoration and obtains utilization and improvement.

### BACKGROUND OF THE INVENTION

It is known to use a light string winding around a Christmas tree for providing decorative effect by the lighting of bulbs or lamps of the light string, as shown in FIG. 1. The conventional light string always includes a preset total length with a fixed number of bulbs. When one light string is not long enough and two or more strings are provided, every string must have its plug-end- extend downward to seek a related socket that will be very inconvenient. A known improved structure has the light string become a socket at the other end for connecting with a plug of another light string to form a longer one. But this makes the string having a lower voltage and the bulbs then perform weakly lighting effect.

Moreover, it is known that the traditional lighting sources include two kinds, one of which is C-type lamp (1), as shown in FIG. 2. It includes a better lighting effect since the lamps (1) are parallelly connected. But the length of this string is fixed and limited. Another shown in FIG. 3 includes miniature bulbs (3), each of which are serially connected. In order to be applied on a Christmas tree in prior art, a branch string (B) is provided. This branch string (B) has one end become a connector (21) to connect with a holder (22) on a main string (A). It can be found that a main string (A) may have several branch strings (B) for winding around a Christmas tree easily. A drawback of this structure is that the connection between the bulbs is still serially and the bulbs (2) have poor performance of lighting because of the voltage drop. Further, the engagement between branch string (B) and the main string (A) is not strong enough. The branch string (B) is usually released from the main string (A) and all bulbs (2) thereon are out of work. A U.S. Pat. (No. 6,612,864) shows a similar structure with the same drawback and is to be improved.

The present invention provides a decorative light string with C-type lamps, which includes branch strings having screw-head for engaging with a holder of a main string in secure to overcome the drawback of the prior arts. Now, accompanying with the following drawings, the character of the present invention will be described here and after.

### BRIEF DESCRIPTION OF THE DRAWINGS

FIG. 1 is a plan view showing a Christmas tree winding with light strings.

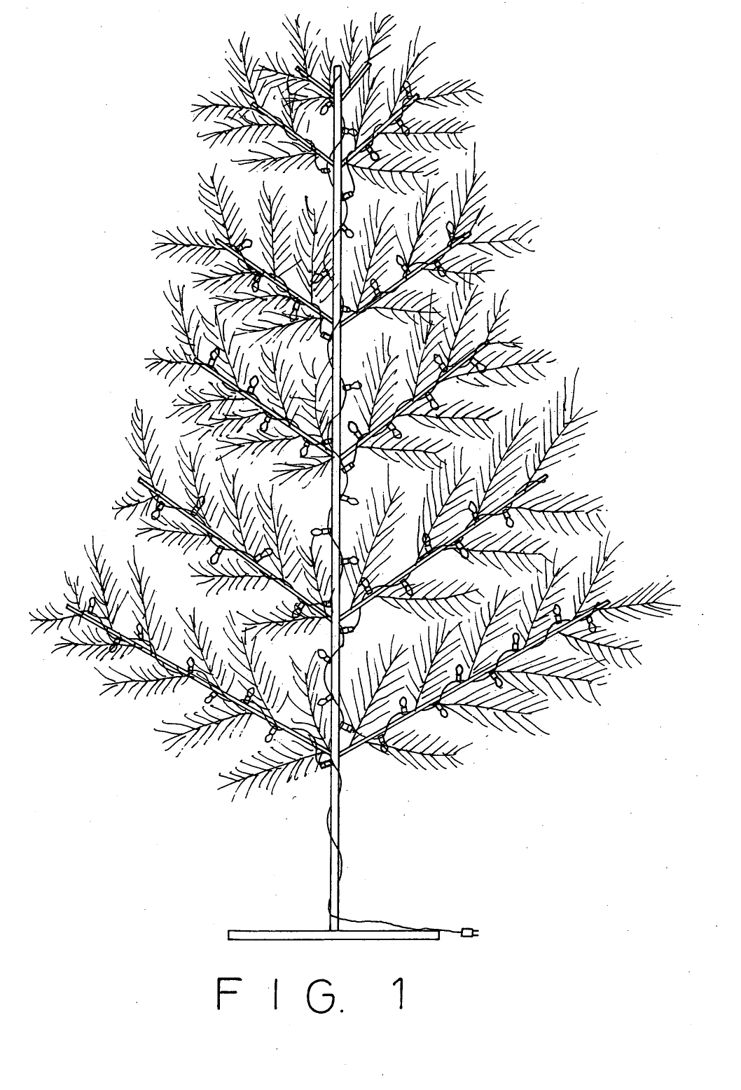

FIG. 2 is a plan view showing a traditional light string including C-type lamps.

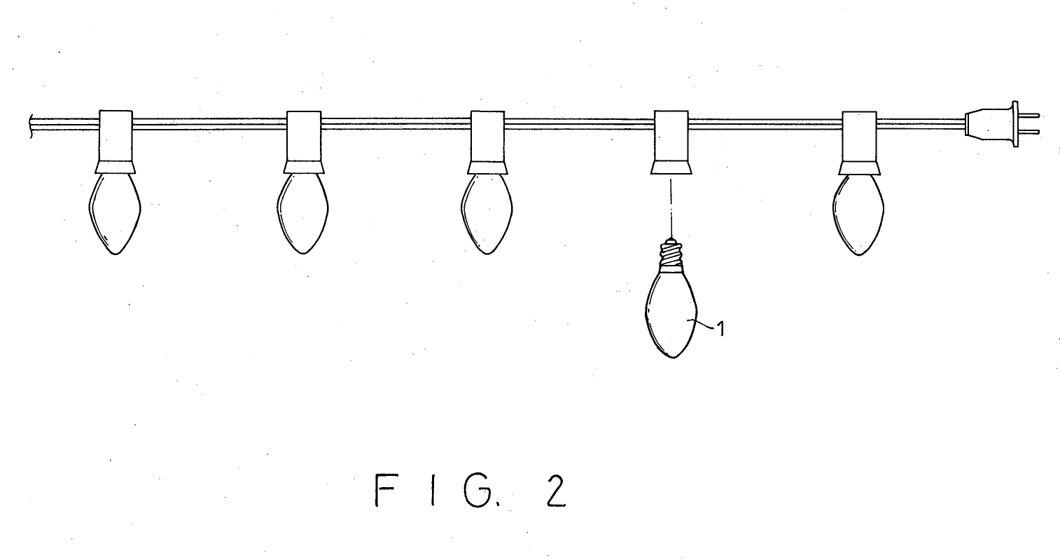

FIG. 3 is a plan view showing a traditional light string including miniature bulbs and a branch string.

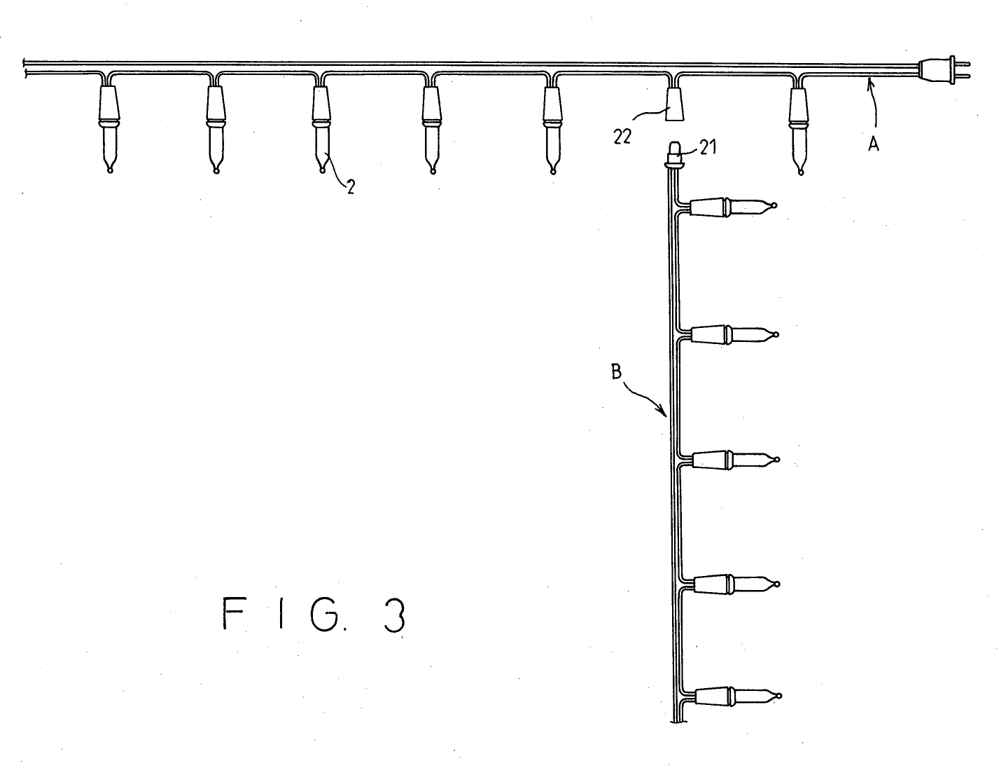

FIG. 4 is a plan view showing a branch string with C-type lamps according to the present invention.

FIG. 5 is a plan view showing a decorative light string with C-type lamps and branch strings having C-type lamps according to the present invention.

### DETAILED DESCRIPTION OF THE PREFERRED EMBODIMENT

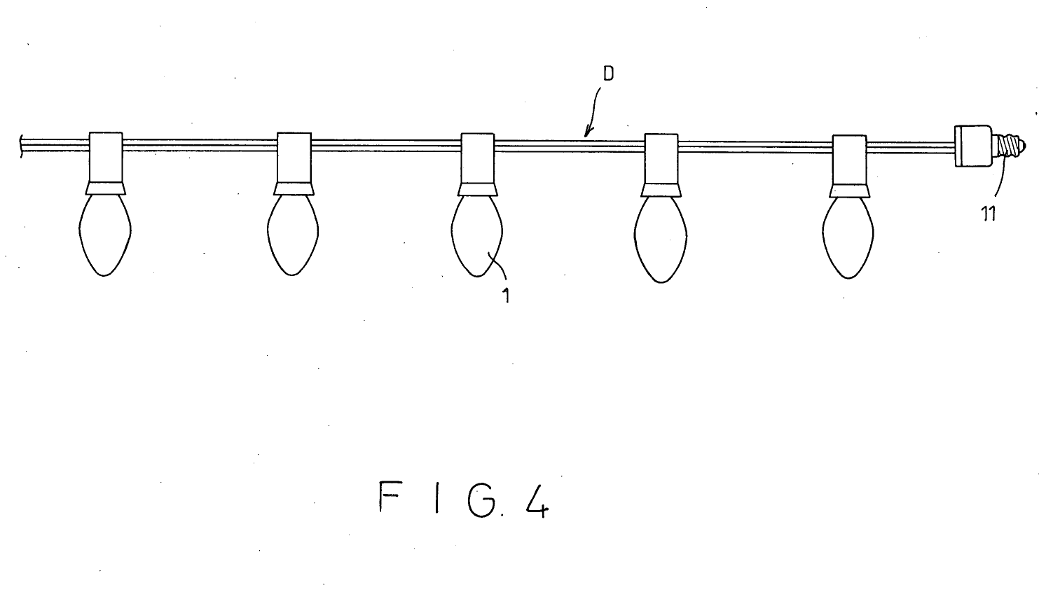

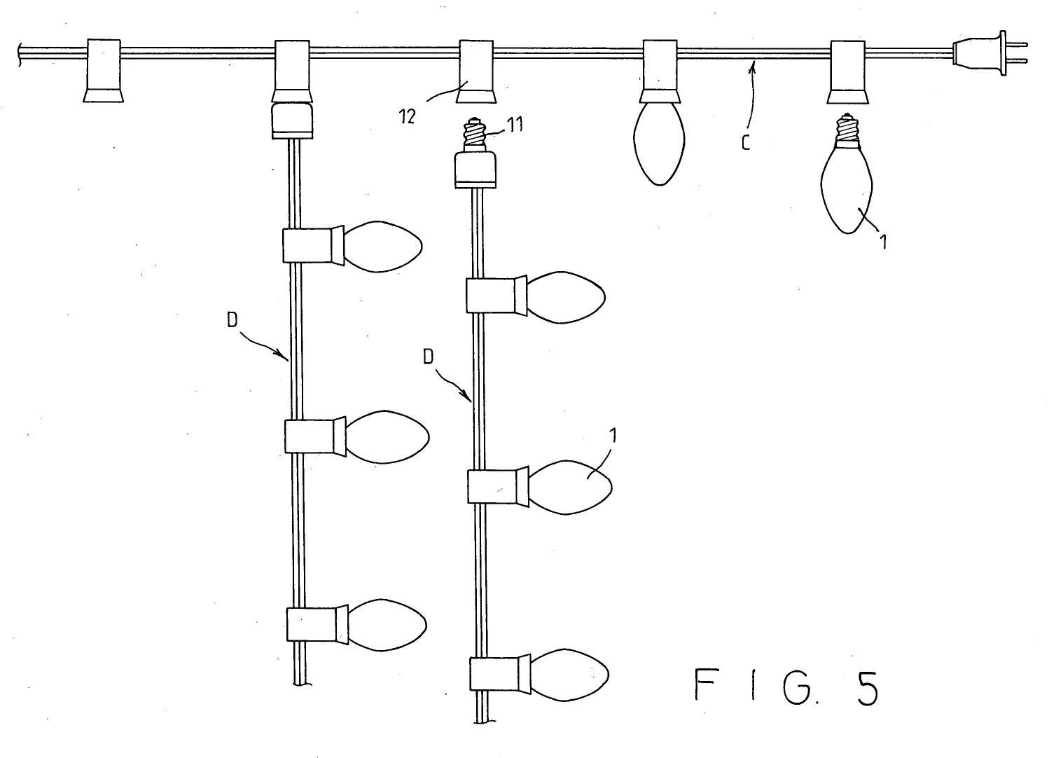

Referring to FIGS. 4 and 5, the present invention relates to an improvement of a light string with C-type lamps (1), which includes a branch string (D) having one end a screw-head (11) as a head of the lamp (1). A main light string (C) has several lamp holders (12) to engage with related C-type lamps (1). The branch string (D) can have its screw-head (11) engage with a holder (12) of the main string (C). Hence, the main light string (C) includes C-type lamps (1) and several branch strings (D) for facilitating the application on a Christmas tree or other decorations.

Since the branch string (D) is screwed with the holder (12), it will be obviously firm for preventing releasing from the main light string. And the C-type lamps (1) are still connected in parallel that makes sure to emit light with enough effect.

Hence, the present invention obviously obtains improvement and should be allowed for a patent. It is also to be understood that the above-mentioned embodiments are only exemplary of the present invention. Any modification with the same or similar merit is still claimed in this application.

1. A decorative light string with C-type lamps having a plurality of lamp holders and a C-type screw-head connected to one end thereof for engaging with a C-type lamp holder of another light string with C-type lamps.

2. A decorative light string with C-type lamps comprising:
a main light string having a plurality of lamp holders, a potion of the plurality of lamp holders being engaged with a multiplicity of corresponding C-type lamps, and
at least one branch string having a plurality of lamp holders and a C-type screw-head coupled to one end thereof the C-type screw-head being engaged with a respective one of the plurality of lamp holders of the main light string.
